(19) United States
(12) Patent Application Publication
(10) Pub. No.: US 2016/0126992 A1
(43) Pub. Date: May 5, 2016

(54) Inter-Radio Access Technology Spur Mitigation

(71) Applicant: QUALCOMM Incorporated, San Diego, CA (US)

(72) Inventors: An-swol Clement Hu, Belmont, CA (US); Ashish Gaonekar, Hyderabad (IN); Narendra Varma Gottimukkala, San Diego, CA (US); Amirreza Khajehnasiri, Encinitas, CA (US); Patrick Lim, San Diego, CA (US); Sridhar Bandaru, Westminster, CO (US); Erdogan Dede, San Diego, CA (US); Reza Shahidi, San Diego, CA (US)

(21) Appl. No.: 14/680,251

(22) Filed: Apr. 7, 2015

(30) Foreign Application Priority Data
Oct. 31, 2014 (IN) 3453/MUM/2014

(51) Int. Cl. H04B 1/12

(52) U.S. Cl. CPC H04B 1/12

(57) ABSTRACT

Various embodiments provide methods, devices, and non-transitory processor-readable storage media for mitigating local oscillator (LO) spur interference between radio access technologies (RATs) operating on a multi-active communication device. The various embodiments provide methods, devices, and non-transitory processor-readable storage media to determine residual frequency error for a multi-active communication device and generate LO spur handling tables that may enable the multi-active communication device to compensate for the residual frequency error. A multi-active communication device may mitigate LO spurs by applying mitigation techniques to one or more RATs according to the LO spur handling tables. A multi-active communication device may mitigate LO spurs by turning off a LOs for one or more RATs according to the LO spur handling tables.

### RELATED APPLICATIONS

The present application claims priority to Indian Application No. 3453/MUM/2014, entitled “Inter-Radio Access Technology Spur Mitigation,” filed Oct. 31, 2014, the entire contents of which are hereby incorporated by reference.

### BACKGROUND

Some new designs of multi-active communication devices—such as smart phones, tablet computers, and laptop computers—include two or more radio access technologies (“RATs”) that enable the devices to connect to two or more radio access networks. Examples of radio access networks include Global System for Mobile Communications (GSM) networks, Time Division Synchronous Code Division Multiple Access (TD-SCDMA) networks, Code Division Multiple Access 2000 (CDMA2000) networks, Long Term Evolution (LTE) networks, and Wideband Code Division Multiple Access (WCDMA) networks. Such multi-active communication devices (sometimes referred to as “multi-active communication devices”) may also include two or more radio-frequency (RF) communication circuits or “RF resources” to provide users with access to separate networks via the two or more RATs.

Multi-active communication devices may include multi-active communication devices (i.e., multi-Subscriber-Identity-Module (SIM), multi-active or “MSMA” communication devices) with a plurality of SIM cards that are each associated with a different RAT and utilize a different RF resource to connect to a separate mobile telephony network. An example multi-active communication device is a “dual-SIM-dual-active” or “DSDA” communication device, which includes two SIM cards/subscriptions associated with two mobile telephony networks. Further, some newer multi-active communication devices may include one or more SIMs/subscriptions capable of using multiple RATs (sometimes referred to as “global mode” subscriptions) simultaneously or at different times. For example, a global mode subscription may be included on a single-SIM communication device, such as a simultaneous GSM+LTE (“SGLTE”) communication device, which includes one SIM card/subscription associated with two RATs that each use an RF resource to connect to two separate mobile networks simultaneously on behalf of the one subscription.

When a multi-active communication device includes a plurality of RATs, each RAT on the device may utilize a different RF resource to communicate with an associated network at any time. For example, a first RAT (e.g., a GSM RAT) may use a first transceiver to transmit to a GSM base station at the same time a second RAT (e.g., a WCDMA RAT) uses a second transceiver to transmit to a WCDMA base station. However, because of the proximity of the antennas of the RF resources included in a multi-active communication device, the simultaneous use of the RF resources may cause one or more RF resources to desensitize or interfere with the ability of the other RF resources to operate normally.

Generally, multi-active communication devices suffer from a number of problems when two RATs are operating (transmitting or receiving) at the same time. One such problem is due to a type of interference caused by two local oscillators within a multi-active communication device interacting to generate spurious tones that are referred to as “spurs.”

### SUMMARY

Various embodiments provide methods, devices, and non-transitory processor-readable storage media for mitigating local oscillator (LO) spur interference between radio access technologies (RATs) operating on a communication device, for example a multi-active communication device. The various embodiments provide methods, devices, and non-transitory processor-readable storage media to determine residual frequency error for a communication device, such as a multi-active communication device, and generate LO spur handling tables that may enable the communication device to compensate for the residual frequency error. Methods for mitigating LO spur interference between RATs operating on a communication device, such as a multi-active communication device, according to the various embodiments include registering operating frequencies of a first RAT and a second RAT, determining LO frequencies for the first RAT and the second RAT based on the registered operating frequencies of the first RAT and the second RAT, determining a residual frequency error for the communication device, generating a LO spur handling table based on the LO frequency for the first RAT and the second RAT and the residual frequency error for the communication device, identifying conflicts based on RAT activity periods of both the first RAT and the second RAT, and implementing mitigation for identified conflicts based on the LO spur handling table.

In some embodiments, the LO spur handling table may correlate spur handling instructions, spur frequency offsets, and spur frequency strengths. In some embodiments, the LO spur handling table may correlate spur handling instructions and victim frequencies.

In some embodiments, identifying conflicts based on RAT activity periods of both the first RAT and the second RAT may include identifying conflicts based on RAT activity periods, activities, and activity priorities of both the first RAT and the second RAT. In some embodiments, the methods may further include registering the RAT activity periods, activities, and activity priorities of both the first RAT and the second RAT. In some embodiments, the first RAT and the second RAT may be operating concurrently.

In some embodiments, implementing mitigation for identified conflicts based on the LO spur handling table may include applying a mitigation technique to the first RAT or the second RAT according to the LO spur handling table. In some embodiments, the mitigation technique may be notch filtering.

In some embodiments, implementing mitigation for identified conflicts based on the LO spur handling table may include turning off an LO of the first RAT or the second RAT based on the LO spur handling table. In some embodiments, turning off an LO of the first RAT or the second RAT based on the LO spur handling table may be based at least in part on a relative priority between activities of the first RAT and the second RAT.

In some embodiments, the operating frequencies of the first RAT and second RAT may be ARFCNs, inter-RAT frequencies, and/or neighbor cell frequencies.

Various embodiments may include a communication device, such as a multi-active communication device, configured with processor-executable instructions to perform operations of the methods described above.

Various embodiments may include a communication device, such as a multi-active communication device, having means for performing functions of the operations of the methods described above.

Various embodiments may include non-transitory processor-readable media on which are stored processor-executable instructions configured to cause a processor of a communication device, such as a multi-active communication device, to perform operations of the methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a communication system block diagram of mobile telephony networks suitable for use with various embodiments.

FIG. 2 is a component block diagram of a multi-active communication device according to various embodiments.

FIG. 3 is a component block diagram illustrating the interaction between components of different transmit/receive chains in a multi-active communication device according to various embodiments.

FIG. 4A is a process flow diagram illustrating a method for determining residual frequency error for a multi-active communication device and generating/updating LO spur handling tables according to various embodiments.

FIG. 4B is a call flow diagram illustrating example interactions between modules of a multi-active communication device to determine residual frequency error and generate/update LO spur handling tables according to various embodiments.

FIG. 5A is a process flow diagram illustrating a method for implementing mitigation for conflicts based on LO spur handling tables according to various embodiments.

FIG. 5B is a call flow diagram illustrating example interactions between modules of a multi-active communication device to apply mitigation techniques to one or more RATs according to the LO spur handling tables.

FIG. 5C is a call flow diagram illustrating example interactions between modules of a multi-active communication device to mitigate LO spurs by turning off a LOs for one or more RATs according to the LO spur handling tables.

FIG. 6 is a component block diagram of a communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the disclosure or the claims.

As used herein, the term “multi-active communication device” is used interchangeably and refer to any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, and similar personal electronic devices that include a programmable processor, memory, and circuitry for connecting to at least two mobile communication networks. The various aspects may be useful in multi-active communication devices, such as smart phones, and so such devices are referred to in the descriptions of various embodiments. However, the embodiments may be useful in any electronic devices, such as multi-Subscriber-Identity-Module (SIM) communication devices (e.g., multi-SIM multi-active (MSMA) or multi-SIM multi-standby (MSMS) communication devices), with a plurality of SIM cards that are each associated with a different RAT and utilize a different RF resource to connect to a separate mobile telephony network, or such as a DSDA communication device, a “dual-SIM-dual-standby” or “DSDS” communication device, etc., that may individually maintain a plurality of RATs that may utilize a plurality of separate RF resources.

Multi-active communication devices have a plurality of RF resources capable of supporting a plurality of RATs capable of receiving and transmitting simultaneously. As described, one or more RATs on a multi-active communication device may negatively affect the performance of other RATs operating on the multi-active communication device. For example, a multi-active communication device may suffer from inter-RAT coexistence interference when an aggressor RAT is attempting to transmit while a victim RAT is simultaneously attempting to receive transmissions. During such a “coexistence event,” the aggressor RAT's transmissions may cause severe impairment to the victim RAT's ability to receive transmissions. This interference may be in the form of blocking interference, harmonics (or subharmonics), intermodulation, and other noises and distortion received by the victim, and the frequencies associated with such interference may be referred to as victim frequencies. Such interference on these victim frequencies may significantly degrade the victim RAT's receiver sensitivity, voice call quality, and data throughput. These effects may also result in a reduced network capacity.

Another form of interference experienced in multi-active communication devices involves interactions between two or more local oscillators (LOs) within wireless transceivers that support transmit (Tx) and receive (Rx) operations on different RATs. For example, the different LOs may support dual receive capabilities on DSDA devices by enabling two Rx LOs to support two RATs to simultaneously receive. However, running multiple LOs at the same time on different frequencies may create LO spurs that interfere with the reception of signals by the RATs. LO spurs may be tones or other types of interference that are generated as a function of the LO frequencies. Interference occurs when the LO spurs fall within active Rx bands. These LO spurs may be dynamic in that they shift during inter-frequency and inter-RAT measurements. LO spur interference that impacts the performance of one RAT is referred as impacting a victim RAT.

In overview, various embodiments provide methods, devices, and non-transitory processor-readable storage media for mitigating LO spur interference between RATs operating on a multi-active communication device. Various embodiments provide methods that may be implemented on multi-active communication devices and implemented in software stored on non-transitory processor-readable storage media, to determine residual frequency error for a multi-active communication device and generate LO spur handling tables that may enable the multi-active communication device to compensate for the residual frequency error. In some embodiments, a multi-active communication device may mitigate LO spurs by applying mitigation techniques to one or more RATs according to the LO spur handling tables. In some embodiments, a multi-active communication device may mitigate LO spurs by turning off LOs for one or more RATs according to the LO spur handling tables.

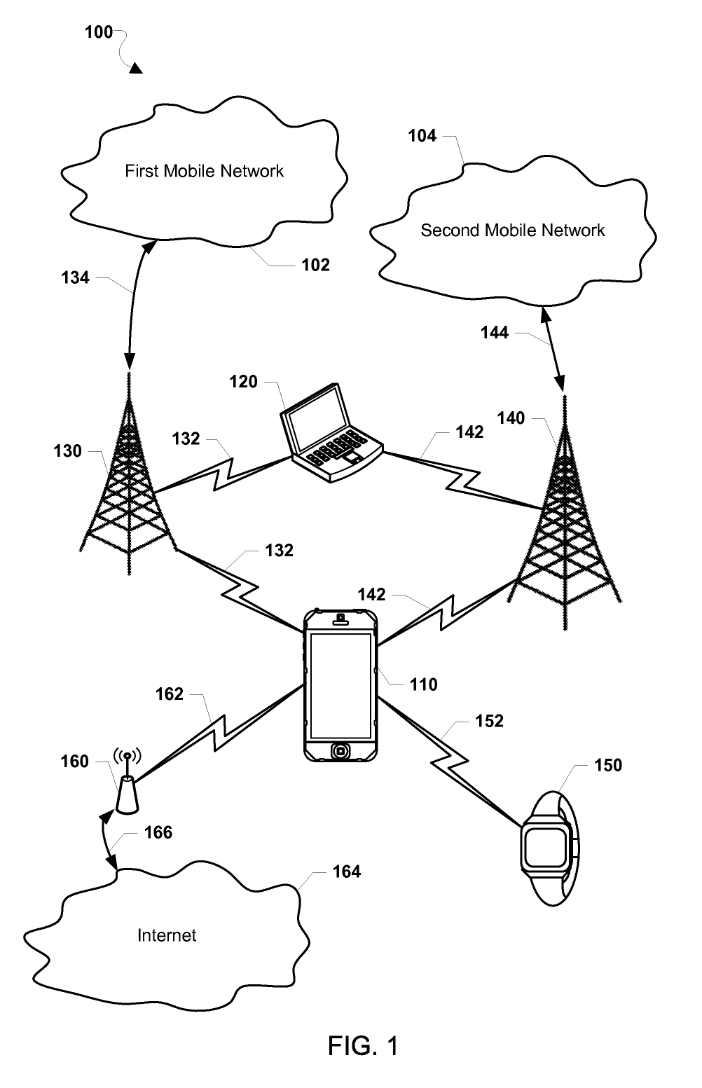

Various embodiments may be implemented within a variety of communication systems 100 that include at least two mobile telephony networks, an example of which is illustrated in FIG. 1. A first mobile network 102 and a second mobile network 104 typically each include a plurality of cellular base stations (e.g., a first base station 130 and a second base station 140). A first multi-active communication device 110 may be in communication with the first mobile network 102 through a cellular connection 132 to the first base station 130. The first multi-active communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second multi-active communication device 120 may similarly communicate with the first mobile network 102 through the cellular connection 132 to the first base station 130. The second multi-active communication device 120 may communicate with the second mobile network 104 through the cellular connection 142 to the second base station 140. The cellular connections 132 and 142 may be made through two-way wireless communication links, such as fourth generation (4G), third generation (3G), Code Division Multiple Access (CDMA), Time Division Multiple Access (TDMA), WCDMA, GSM, LTE, and other mobile telephony communication technologies.

While the multi-active communication devices 110, 120 are shown connected to the mobile networks 102, 104, in some embodiments (not shown), the multi-active communication devices 110, 120 may include one or more subscriptions to two or more mobile networks 102, 104 and may connect to those networks in a manner similar to operations described above.

In some embodiments, the first multi-active communication device 110 may establish a wireless connection 152 with a peripheral device 150 used in connection with the first multi-active communication device 110. For example, the first multi-active communication device 110 may communicate over a Bluetooth® link with a Bluetooth-enabled personal computing device (e.g., a “smart watch”). In some embodiments, the first multi-active communication device 110 may establish a wireless connection 162 with a wireless access point 160, such as over a Wi-Fi connection. The wireless access point 160 may be configured to connect to the Internet 164 or another network over a wired connection 166.

While not illustrated, the second multi-active communication device 120 may similarly be configured to connect with the peripheral device 150 and/or the wireless access point 160 over wireless links.

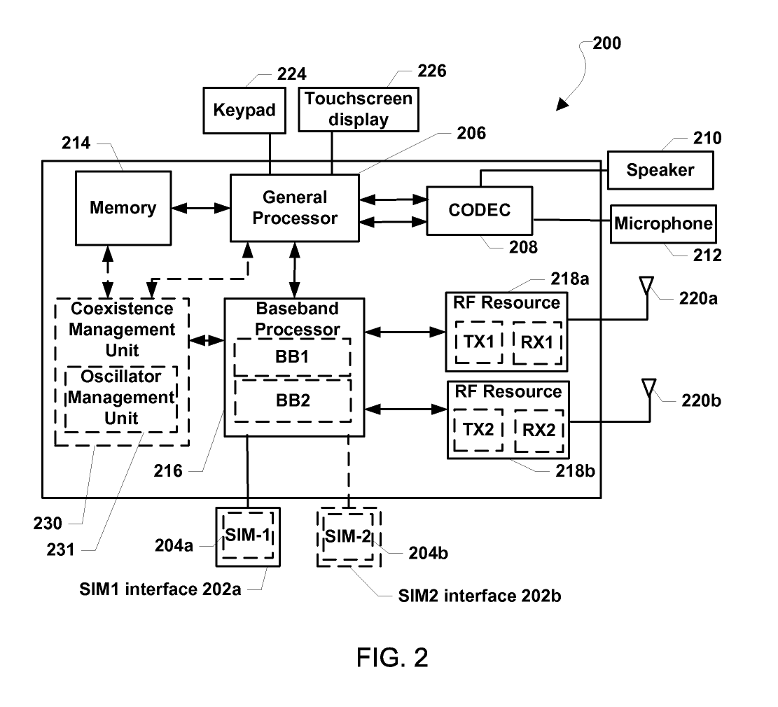

FIG. 2 is a functional block diagram of a multi-active communication device 200 suitable for implementing various embodiments. With reference to FIGS. 1-2, the multi-active communication device 200 may be similar to one or more of the multi-active communication devices 110, 120 as described. The multi-active communication device 200 may include a first SIM interface 202a, which may receive a first identity module SIM-1 204a that is associated with a first subscription. In optional embodiments, the multi-active communication device 200 may optionally include a second SIM interface 202b, which may receive an optional second identity module SIM-2 204b that is associated with a second subscription.

A SIM in various embodiments may be a Universal Integrated Circuit Card (UICC) that is configured with SIM and/or Universal SIM (USIM) applications, enabling access to, for example, GSM and/or Universal Mobile Telecommunications System (UMTS) networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM, and I/O circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number is printed on the SIM card for identification. However, a SIM may be implemented within a portion of memory of the multi-active communication device 200 (e.g., memory 214), and thus need not be a separate or removable circuit, chip or card.

The multi-active communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data, such as an array data structure.

The general processor 206 and the memory 214 may each be coupled to at least one baseband modem processor 216. Each SIM in the multi-active communication device 200 (e.g., the SIM-1 204a and the SIM-2 204b) may be associated with a baseband-RF resource chain. A baseband-RF resource chain may include the baseband modem processor 216, which may perform baseband/modem functions for communicating with/controlling a RAT, and may include one or more amplifiers and radios, referred to generally herein as RF resources (e.g., RF resources 218a, 218b). In some embodiments, baseband-RF resource chains may share the baseband modem processor 216 (i.e., a single device that performs baseband/modem functions for all SIMs on the multi-active communication device 200). In other embodiments, each baseband-RF resource chain may include physically or logically separate baseband processors (e.g., BB1, BB2).

In some embodiments, the RF resources 218a, 218b may be associated with different RATs. For example, a first RAT (e.g., a GSM RAT) may be associated with the RF resource 218a, and a second RAT (e.g., a CDMA or WCDMA RAT) may be associated with the RF resource 218b. The RF resources 218a, 218b may each be transceivers that perform transmit/receive functions on behalf of corresponding RATs. The RF resources 218a, 218b may also include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216.

In some embodiments, the general processor 206, the memory 214, the baseband processor(s) 216, and the RF resources 218a, 218b may be included in the multi-active communication device 200 as a system-on-chip. In some embodiments, the first and second SIMs 204a, 204b and corresponding interfaces 202a, 202b may be external to the system-on-chip. Further, various input and output devices may be coupled to components on the system-on-chip, such as interfaces or controllers. Example user input components suitable for use in the multi-active communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the multi-active communication device 200 to enable communication between them, as is known in the art.

Functioning together, the two SIMs 204a, 204b, the baseband modem processor 216, the RF resources 218a, 218b, and the wireless antennas 220a, 220b may constitute two or more RATs. For example, a SIM, baseband processor and RF resource may be configured to support two different RATs, such as GSM and WCDMA. More RATs may be supported on the multi-active communication device 200 by adding more SIM cards, SIM interfaces, RF resources, and/or antennae for connecting to additional mobile networks.

The multi-active communication device 200 may include a coexistence management unit 230 (also referred to as a coexistence manager) configured to manage and/or schedule the RATs' utilization of the RF resources 218a, 218b and an oscillator management unit 231 (also referred to as an Xo_manager) configured to manage and/or monitor residual frequency errors of the RATs. The coexistence management unit 230 and/or oscillator management unit 231 may manage two RATs and/or subscriptions and two or more LOs to mitigate LO spur interference between RATs as described herein.

In some embodiments, the coexistence management unit 230 and/or oscillator management unit 231 may be implemented within the general processor 206. In some embodiments, the coexistence management unit 230 and/or oscillator management unit 231 may be implemented as a separate hardware component (i.e., separate from the general processor 206). In some embodiments, the coexistence management unit 230 and/or oscillator management unit 231 may be implemented as a software application stored within the memory 214 and executed by the general processor 206. In some embodiments, the oscillator management unit 231 may be a subcomponent of the coexistence management unit 230. In some embodiments, the oscillator management unit 231 may be separate from the coexistence management unit 230. In various embodiments, the coexistence management unit 230, oscillator management unit 231, baseband processor 216, RF resources 218a, 218b, and/or SIMs 204a, 204b may be implemented in hardware, software, firmware, or any combination thereof.

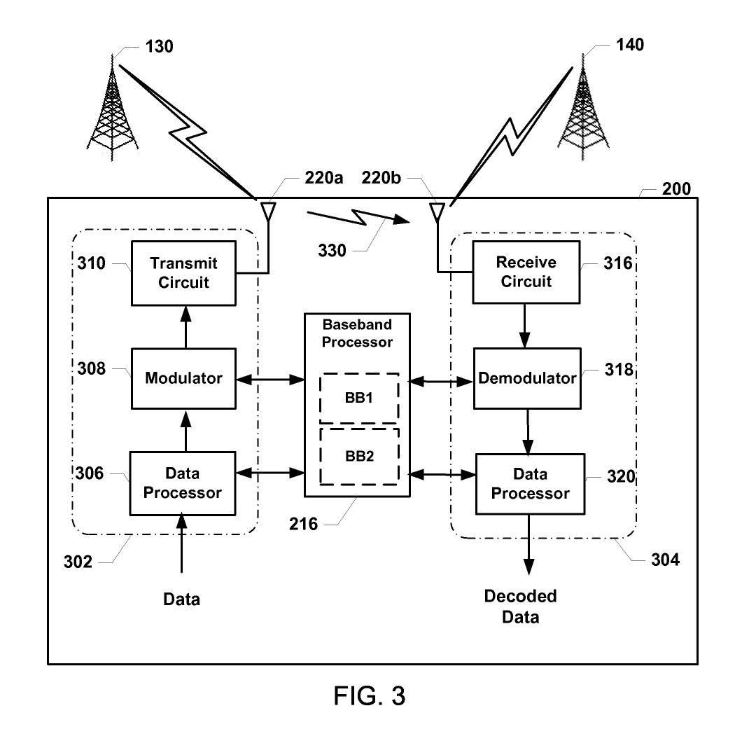

FIG. 3 is a block diagram of transmit and receive components in separate RF resources on a multi-active communication device 200 according to various embodiments. With reference to FIGS. 1-3, a transmitter 302 may be part of the RF resource 218a, and a receiver 304 may be part of the RF resource 218b.

In some embodiments, the transmitter 302 may include a data processor 306 that may format, encode, and interleave data to be transmitted. The transmitter 302 may include a modulator 308 that modulates a carrier signal with encoded data, such as by performing Gaussian minimum shift keying (GMSK). One or more transmit circuits 310 may condition the modulated signal (e.g., by filtering, amplifying, and upconverting) to generate an RF modulated signal for transmission. The RF modulated signal may be transmitted to the first base station 130 via the first wireless antenna 220a, for example. The transmitter 302 may be associated with a first LO.

In the receiver 304, the second wireless antenna 220b may receive RF modulated signals from the second base station 140 on the second wireless antenna 220b. However, the second wireless antenna 220b may also receive some RF signaling 330 from the transmitter 302, which may ultimately compete with the desired signal received from the second base station 140. One or more receive circuits 316 may condition (e.g., filter, amplify, and downconvert) the received RF modulated signal, digitize the conditioned signal, and provide samples to a demodulator 318. The demodulator 318 may extract the original information-bearing signal from the modulated carrier wave, and may provide the demodulated signal to a data processor 320. The data processor 320 may de-interleave and decode the signal to obtain the original, decoded data, and may provide decoded data to other components in the multi-active communication device 200.

The receiver 304 may be associated with a second LO, different from the first LO of the transmitter 302. Operations of the transmitter 302 and the receiver 304 may be controlled by a processor, such as the baseband modem processor 216. In various embodiments, each of the transmitter 302 and the receiver 304 may be implemented as circuitry that may be separated from corresponding receive and transmit circuitries (not shown). Alternatively, the transmitter 302 and the receiver 304 may be respectively combined with corresponding receive circuitry and transmit circuitry, for example, as transceivers associated with the SIM-1 204a and the SIM-2 204b.

Receiver de-sense may occur when transmissions by a first RAT on the uplink (e.g., the RF signaling 330) interferes with receive activity on a different transmit/receive chain associated with a second RAT. The signals received by the transmit/receive chain associated with the second RAT may become corrupted and difficult or impossible to decode as a result of the de-sense or interference. Further, noise from the transmitter 302 may be detected by a power monitor (not shown) that measures the signal strength of surrounding cells, which may cause the multi-active communication device 200 to falsely determine the presence of a nearby cell site.

Because running multiple LOs at the same time on different frequencies may create LO spurs that interfere with the reception by the RATs, various embodiments mitigate LO spur interference between the RATs operating on a multi-active communication device.

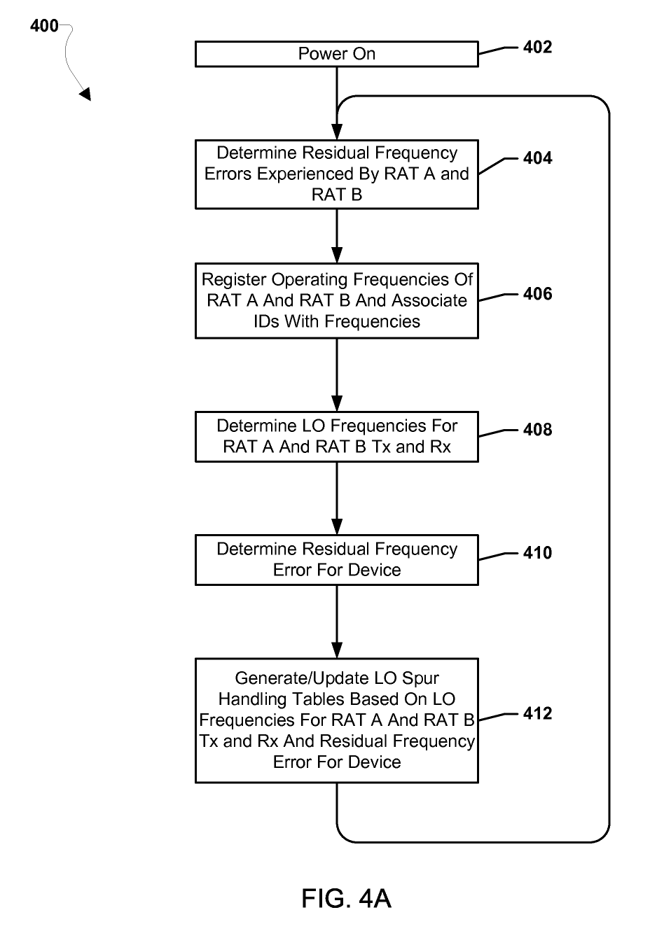

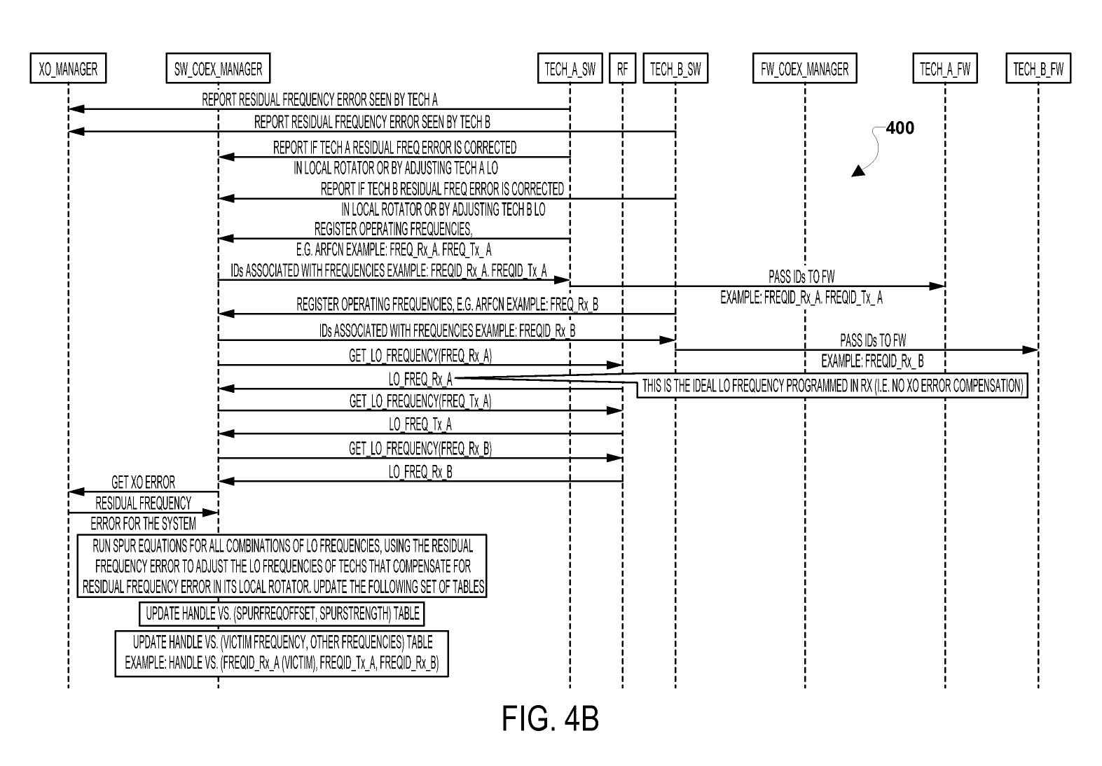

FIG. 4A illustrates a method 400 for determining residual frequency errors for a multi-active communication device and generating/updating LO spur handling tables according to various embodiments. With reference to FIGS. 1-4A, the method 400 may be implemented with a processor (e.g., the general processor 206, the baseband modem processor 216, the coexistence management unit 230, the oscillator management unit 231, a separate controller, and/or the like) on a multi-active communication device (e.g., the multi-active communication device 200). In various embodiments, the operations of method 400 may be performed by the device processor repetitively at a set time period, such as a millisecond time period. The device processor may begin performing operations of the method 400 in response to the multi-active communication device's powering on in block 402.

In block 404, the device processor may determine residual frequency errors experienced by RAT A and RAT B. For example, each of RAT A and RAT B may report the residual error frequency experienced by that RAT, and may report whether the residual error frequency is corrected by a local rotator to enable the residual frequency errors to be determined. In block 406, the device processor may register the operating frequencies of RAT A and RAT B and associate identifiers (IDs) with the frequencies. For example, each RAT may report respective absolute radio frequency channel numbers (ARFCNs), inter-RAT frequencies, and/or neighbor frequencies, and each frequency may be associated with an ID.

In block 408, the device processor may determine LO frequencies for transmissions (Tx) and receptions (Rx) for each of RAT A and RAT B that may also account for multi-carrier frequencies. In block 410, the device processor may determine the residual frequency error for the multi-active communication device. As an example, the residual error frequency for the multi-active communication device may be the residual error frequency accounting for the residual frequency error experienced by RAT A and RAT B.

In block 412, the device processor may generate and/or update LO spur handling tables based on the LO frequencies for RAT A and RAT B Tx and Rx and the residual frequency error for the multi-active communication device. For example, the device processor may run spur equations for all combinations of LO frequencies using the residual error to adjust the LO frequencies of the RATs that compensate for residual frequency error in local rotators and update one or more LO spur handling table, such as a handling versus spur frequency offset and strength table and/or a handling versus victim frequency and other frequency table.

FIG. 4B is a call flow diagram 450 illustrating example interactions between modules of a multi-active communication device to determine residual frequency error and generate/update LO spur handling tables according to various embodiments. With reference to FIGS. 1-4B, the call flows of the call flow diagram 450 may be implemented with a processor (e.g., the general processor 206, the baseband modem processor 216, the coexistence management unit 230, the oscillator management unit 231, a separate controller, and/or the like) on a multi-active communication device (e.g., the multi-active communication device 200). In various embodiments, the exchanges illustrated in the call flow diagram 450 may be implemented by various device processor layers, such as oscillator management unit (Xo_manager), coexistence manager software (SW_Coex_Manager), RAT A software (Tech_A_SW), wireless transceiver drivers (RF), RAT B software (Tech_B_SW), coexistence manager firmware (FW_Coex_Manager), RAT A firmware (Tech_A_FW), and/or, RAT B firmware (Tech_B_FW), to perform operations of method 400.

The exchanges illustrated in the call flow diagram 450 may enable the device processor to determine residual frequency error and generate/update LO spur handling tables. Tech_A_SW and Tech_B_SW may inform the SW_Coex_Manager regarding whether the respective RAT A or RAT B compensates for residual frequency error in the LO or whether the respective RAT A or RAT B adjusts the LO of the RAT. The indications from the RATs may impact how the SW_Coex_Manager may estimate the LO frequency. In some embodiments, all RATs may use the same mitigation technique, such as either all RATs may use frequency error compensation in the LO or all RATS may mitigate by adjusting respective LOs. The use of the same mitigation technique by all RATS may reduce the variability in the spur position. In some embodiments, the RATs may use different mitigation techniques.

Tech_A_SW and Tech_B_SW may next register the active frequencies (Tx and Rx) as well as frequencies that are expected to be active in the near future (e.g., inter-freq and inter-RAT frequencies). SW_Coex_Manager may then assign “frequency IDs” for the reported frequencies. The SW_Coex_Manager may query the RF to obtain the LO frequency programmed for Tech_A_SW and Tech_B_SW. The SW_Coex_Manager may then query the Xo_manager to obtain the expected residual frequency error.

With the determined LO frequencies and residual frequency error, the SW_Coex_Manager may compute the LO frequency for each LO. Specifically, for a given RAT, when the RAT uses a local rotator to compensate for residual frequency offset, the actual LO frequency may be computed as the LO frequency from the RF adjusted by the residual frequency error obtained from Xo_manager. When the RAT compensates for residual frequency offset by adjusting the LO frequency directly, then the LO frequency obtained from the RF may be used as the actual LO frequency. For inter-freq/inter-RAT frequencies, the ideal ARFCN frequency may be used as the LO frequency from the RF. Using the determined LO frequencies, the SW_Coex_Manager may pre-compute the expected spurs using all coefficient sets in the relevant band combinations to generate and/or update LO spur handling tables. The LO spur handling tables indicating the expected spurs may be formatted for quick look-up when actual frequency conflicts are evaluated. Specifically, a handle may be assigned for a given set of active frequencies that result in at least one spur. This handle may then be associated with the spur details, such as spur offset and strength, in the LO spur handling tables. In the various embodiments, more than one spur may be associated with a given handle in the LO spur handling tables.

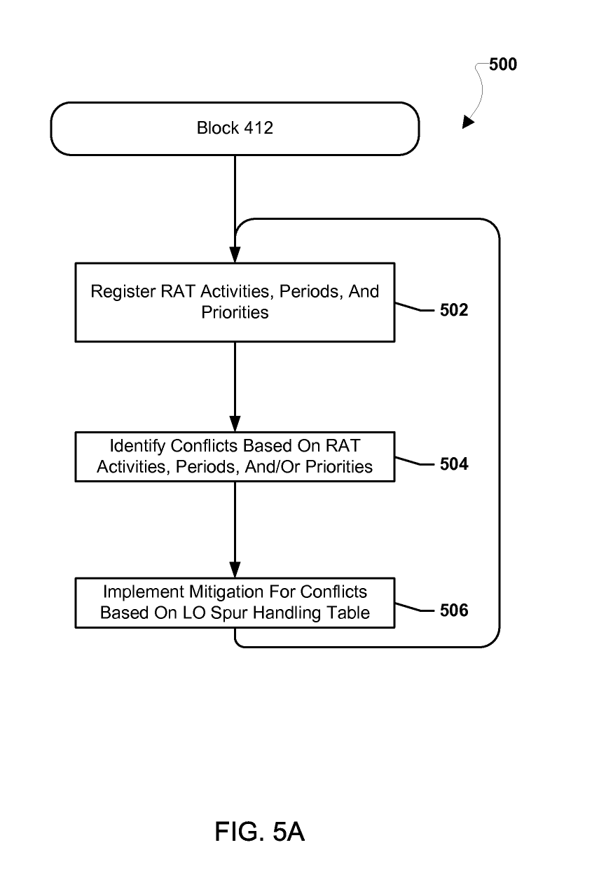

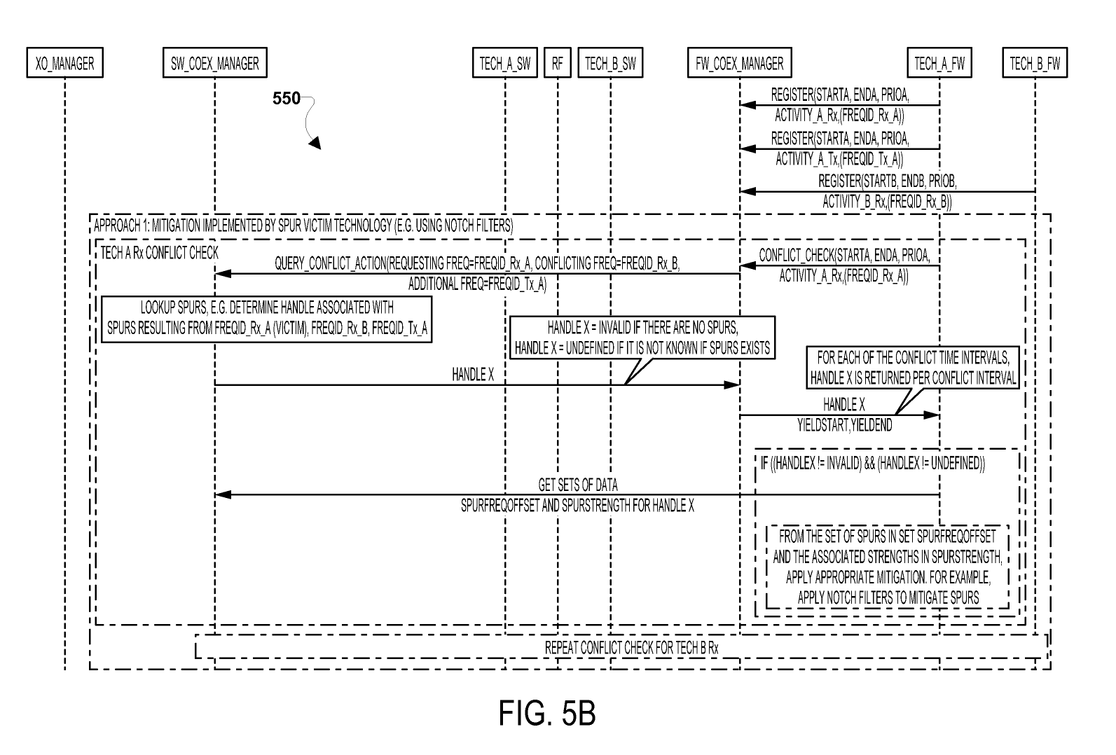

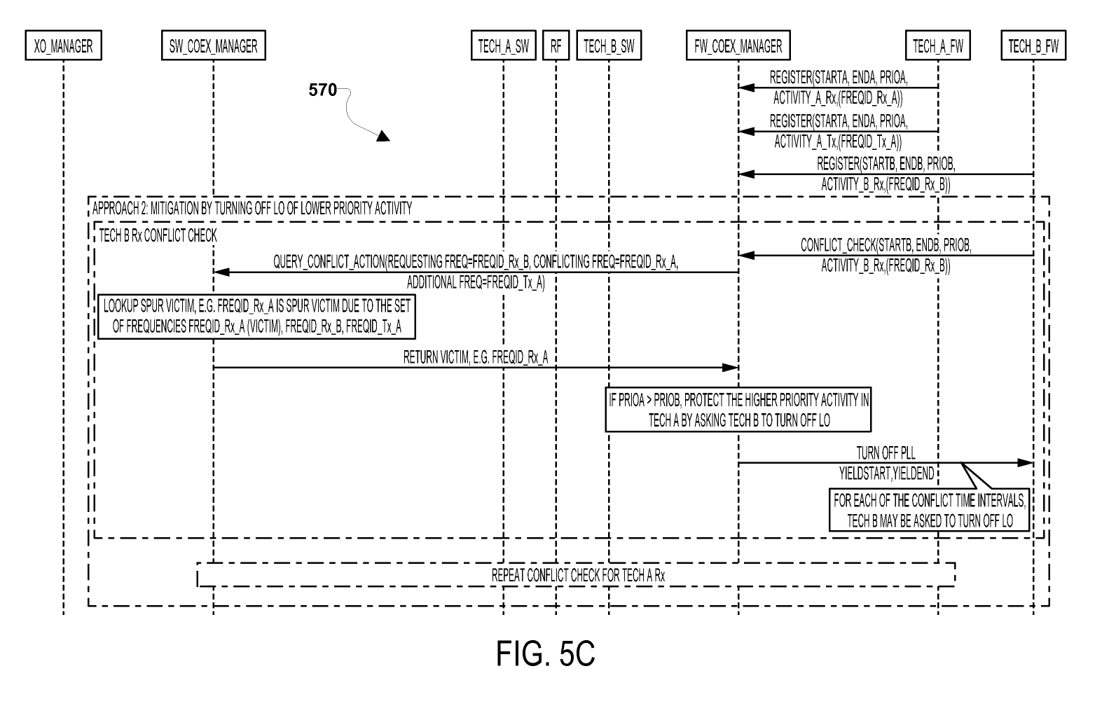

FIG. 5A is a process flow diagram illustrating a method 500 for implementing mitigation for conflicts based on LO spur handling tables according to some embodiments. With reference to FIGS. 1-5A, the method 500 may be implemented with a processor (e.g., the general processor 206, the baseband modem processor 216, the coexistence management unit 230, the oscillator management unit 231, a separate controller, and/or the like) on a multi-active communication device (e.g., the multi-active communication device 200). In various embodiments, the operations of method 500 may be performed by the device processor repetitively at a set time period, such as a millisecond time period. The operations of the method 500 may be performed after the operations performed in the method 400. Thus, the device processor may begin performing operations of the method 500 in response to generate/update LO spur handling tables in block 412 of the method 400.

In block 502, the device processor may register RAT activities, periods, and priorities. For example, each RAT may register activities on the Tx and Rx frequencies of the RAT, the frequency IDs assigned to those frequencies, the start and stop times of those activities, and the priority of those activities. Each RAT may continually register respective activities and frequencies over short registration intervals. Both RATs may operate concurrently on the multi-active communication device, and the device processor may concurrently receive registrations of activities from both RATs. Specifically, the RAT may indicate that over a registration interval (e.g., 1 ms), there may be one or more sub intervals during which the RAT may be associated with a frequency, activity, and priority. Activity registration may be used to denote specific operations, such as the act of tuning to a frequency. The registration of specific operations may allow the RATs to separately specify the “tuning” portion of time and the time at which the RAT may reach “steady-state” in a new frequency. In the event that different mitigation behavior needs to be defined for the tuning portion, an appropriate action may be defined for conflicts with “tuning” in the LO spur handling tables.

In block 504, the device processor may identify conflicts between the activities of the RATs based on the registered RAT activities, periods, and/or priorities. For example, using the generated LO spur lookup tables, the device processor may determine whether any LO spurs will be generated on RATs based on the frequencies used by the respective RATs during overlapping periods. The device processor may continually check for conflicts between RATs and may look ahead over a conflict check interval that may be a period of time set so that potential conflicts may be acted upon before they may occur. In various embodiments, the conflicts may be identified at least in part based on the activity periods of the RATs. In various embodiments, additional attributes of the RATs, such as the RATs' activities and activity priorities, may be used separately, or in conjunction with the RATs' activity periods, to identify conflicts.

In block 506, the device processor may implement mitigation for conflicts discovered based on the handling instructions in the LO spur handling tables correlated with any conflicting frequencies. For example, the device processor may apply mitigation techniques, such as notch filtering, to the victim RAT based on handling instructions in the LO spur handling tables. As another example, the device processor may turn off an LO for one or more RAT to mitigate LO spurs based on handling instructions in the LO spur handling tables.

FIG. 5B is a call flow diagram 550 illustrating example interactions between modules of a multi-active communication device to apply mitigation techniques to one or more RATs according to the LO spur handling tables. With reference to FIGS. 1-5B, the call flows illustrated in the call flow diagram 550 may be implemented with a processor (e.g., the general processor 206, the baseband modem processor 216, the coexistence management unit 230, the oscillator management unit 231, a separate controller, and/or the like) on a multi-active communication device (e.g., the multi-active communication device 200). In various embodiments, the exchanges illustrated in the call flow diagram 550 may be implemented by various device processor layers, such as oscillator management unit (Xo_manager), coexistence manager software (SW_Coex_Manager), RAT A software (Tech_A_SW), wireless transceiver drivers (RF), RAT B software (Tech_B_SW), coexistence manager firmware (FW_Coex_Manager), RAT A firmware (Tech_A_FW), and/or, RAT B firmware (Tech_B_FW), to perform operations of block 506 of the method 500.

The exchanges illustrated in the call flow diagram 550 may enable the device processor to apply mitigation techniques to one or more RATs according to the LO spur handling tables. For example, based on a query of conflicts between RATs, the handling instruction may provide a start and stop time for a conflict to RAT A along with the frequency offset of the spurs and associated spur strength to enable appropriate mitigation, such as notch filters, to be applied to mitigate the spurs on the victim RAT. When the FW_Coex_Manager obtains a conflict check from a given RAT, the FW_Coex_Manager may look at the registrations from both RATs and determine whether frequencies conflict in time. For a given conflict check interval, there may be multiple sub intervals, each with a different conflict. For a given sub interval, all frequencies involved in the conflict may be sent to the SW_Coex_Manager.

The SW_Coex_Manager may determine whether there is a handle associated with the frequencies involved in the conflict. In response to determining there is no handle, the SW_Coex_Manager may determine that there is no spur. In response to determine that a handle exists, the SW_Coex_Manager may determine that a spur may exist, and the SW_Coex_Manager may return the handle associated with the spur set. The RAT that did the conflict check (e.g., Tech_A_FW or Tech_B_FW) may be informed of the individual sub conflict intervals and a handle associated with each sub interval by the SW_Coex_Manager. In response to determining that there is a valid handle (e.g., a spur exists), the RAT (e.g., Tech_A_FW or Tech_B_FW) may query the SW_Coex_Manager for the details of the spurs using the handle. The RAT (e.g., Tech_A_FW or Tech_B_FW) may then mitigate the spur by using, for example, notch filters. Since the RAT (e.g., Tech_A_FW or Tech_B_FW) may know the interval over which the spur exists as well as the strength of the spur, the RAT (e.g., Tech_A_FW or Tech_B_FW) may make informed choices about how to mitigate the spur. For example, the RAT (e.g., Tech_A_FW or Tech_B_FW) may make the appropriate trade-offs in notch depth, bandwidth, and filter convergence time, as well as choose appropriate times at which to apply the notches to best mitigate the identified spur.

FIG. 5C is a call flow diagram 570 illustrating example interactions between modules of a multi-active communication device to mitigate LO spurs by turning off a LOs for one or more RATs according to the LO spur handling tables. With reference to FIGS. 1-5C, the call flows illustrated in the call flow diagram 570 may be implemented with a processor (e.g., the general processor 206, the baseband modem processor 216, the coexistence management unit 230, the oscillator management unit 231, a separate controller, and/or the like) on a multi-active communication device (e.g., the multi-active communication device 200). In various embodiments, the exchanges illustrated in the call flow diagram 570 may be implemented by various device processor layers, such as oscillator management unit (Xo_manager), coexistence manager software (SW_Coex_Manager), RAT A software (Tech_A_SW), wireless transceiver drivers (RF), RAT B software (Tech_B_SW), coexistence manager firmware (FW_Coex_Manager), RAT A firmware (Tech_A_FW), and/or, RAT B firmware (Tech_B_FW), to perform operations of block 506 of the method 500 of FIG. 5A.

The exchanges illustrated in the call flow diagram 570 may enable the device processor to mitigate LO spurs by turning off a LOs for one or more RATs according to the LO spur handling tables. For example, based on a query of conflicts between RATs, the handling instruction may indicate that the frequency ID of the victim RAT, and based on the priorities of the activities on the RATs the phase lock loop (PLL) of the lowest priority RAT may be turned off (thereby turning off the LO for the lowest priority RAT) for the duration of the conflict. When the FW_Coex_Manager obtains a conflict check from a given RAT (e.g., Tech_A_FW or Tech_B_FW), the FW_Coex_Manager may determine the registered RAT activities, activity periods, and/or activity priorities for both RATs, and determine the frequencies that conflict in time. For a given conflict check interval, there may be multiple sub intervals, each with a different conflict. For a given sub interval, all frequencies involved in the conflict may be sent to the SW_Coex_Manager.

The SW_Coex_Manager may determine whether there is a spur victim for the frequency combination indicated by the FW_Coex_Manager. The determined victim frequency may be returned to the FW_Coex_Manager by the SW_Coex_Manager. The FW_Coex_Manager may determine the priorities of the activities of the respective RAT and direct the lower priority RAT to turn off the LO of that RAT for a given sub interval. Turning off the LO on the lower priority RAT may eliminate the spur on the higher priority RAT during that given sub interval.

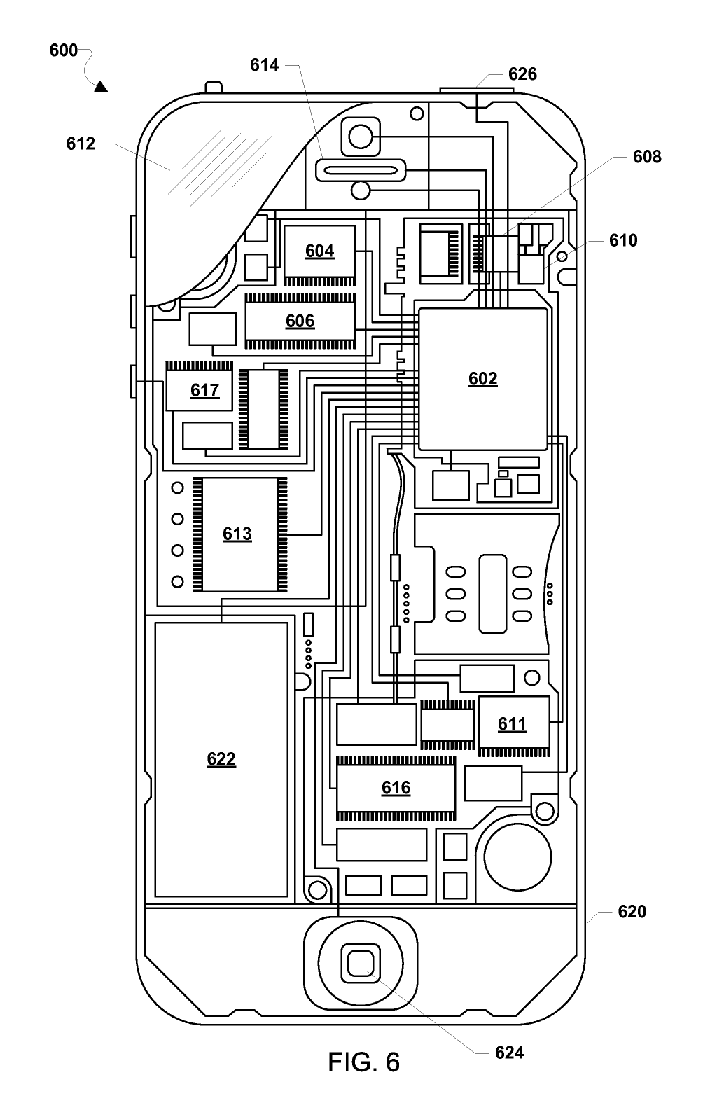

Various embodiments may be implemented in any of a variety of communication devices, an example on which (e.g., multi-active communication device 600) is illustrated in FIG. 6. With reference to FIGS. 1-6, the multi-active communication device 600 may be similar to the multi-active communication devices 110, 120, 200. As such, the multi-active communication device 600 may implement the methods 400 and/or 500.

Thus, the multi-active communication device 600 may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the multi-active communication device 600 need not have touch screen capability.

The multi-active communication device 600 may have one or more cellular network transceivers 608, 616 coupled to the processor 602 and to two or more antennae 610, 611 and configured for sending and receiving cellular communications. The transceivers 608, 616 and the antennae 610, 611 may be used with the above-mentioned circuitry to implement the various embodiment methods. The multi-active communication device 600 may include one or more SIM cards (e.g., SIM 613) coupled to the transceivers 608, 616 and/or the processor 602 and configured as described above. The multi-active communication device 600 may include a cellular network wireless modem chip 617 that enables communication via a cellular network and is coupled to the processor 602.

The multi-active communication device 600 may also include speakers 614 for providing audio outputs. The multi-active communication device 600 may also include a housing 620, constructed of a plastic, metal, or a combination of materials, for containing all or some of the components discussed herein. The multi-active communication device 600 may include a power source 622 coupled to the processor 602, such as a disposable or rechargeable battery. The rechargeable battery may also be coupled to the peripheral device connection port to receive a charging current from a source external to the multi-active communication device 600. The multi-active communication device 600 may also include a physical button 624 for receiving user inputs. The multi-active communication device 600 may also include a power button 626 for turning the multi-active communication device 600 on and off.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the various embodiments. Various modifications to these embodiments will be readily apparent to those skilled in the art, and the generic principles defined herein may be applied to some embodiments without departing from the spirit or scope of the various embodiments. Thus, the various embodiments are not intended to be limited to the examples shown herein but are to be accorded the widest scope consistent with the following claims and the principles and novel features disclosed herein.

What is claimed is:

1. A method for mitigating local oscillator (LO) spur interference between radio access technologies (RATs) operating on a communication device, comprising:
registering operating frequencies of a first RAT and a second RAT;
determining LO frequencies for the first RAT and the second RAT based on the registered operating frequencies of the first RAT and the second RAT;
determining a residual frequency error for the communication device;
generating a LO spur handling table based on the LO frequencies for the first RAT and the second RAT and the residual frequency error for the communication device;
identifying conflicts based on RAT activity periods of both the first RAT and the second RAT; and
implementing mitigation for identified conflicts based on the LO spur handling table.

2. The method of claim 1, wherein the LO spur handling table correlates spur handling instructions, spur frequency offsets, and spur frequency strengths.

3. The method of claim 2, wherein the LO spur handling table correlates spur handling instructions and victim frequencies of the first RAT and the second RAT.

4. The method of claim 1, wherein identifying conflicts based on RAT activity periods of both the first RAT and the second RAT comprises identifying conflicts based on RAT activity periods, activities, and activity priorities of both the first RAT and the second RAT.

5. The method of claim 4, further comprising:
registering the RAT activity periods, activities, and activity priorities of both the first RAT and the second RAT.

6. The method of claim 1, wherein the first RAT and the second RAT are operating concurrently.

7. The method of claim 1, wherein implementing mitigation for identified conflicts based on the LO spur handling table comprises applying a mitigation technique to the first RAT or the second RAT according to the LO spur handling table.

8. The method of claim 7, wherein the mitigation technique is notch filtering.

9. The method of claim 1, wherein implementing mitigation for identified conflicts based on the LO spur handling table comprises turning off an LO of the first RAT or the second RAT based on the LO spur handling table.

10. The method of claim 9, wherein turning off an LO of the first RAT or the second RAT based on the LO spur handling table is based at least in part on a relative priority between activities of the first RAT and the second RAT.

11. The method of claim 1, wherein the operating frequencies of the first RAT and the second RAT are ARFCNs, inter-RAT frequencies, and/or neighbor cell frequencies.

12. A communication device, comprising:
one or more radio frequency (RF) resources; and
a processor coupled to the one or more RF resources and configured with processor-executable instructions to:
register operating frequencies of the a first radio access technology (RAT) and a second RAT;
determine local oscillator (LO) frequencies for the first RAT and the second RAT based on the registered operating frequencies of the first RAT and the second RAT;
determine a residual frequency error for the communication device;
generate a LO spur handling table based on the LO frequencies for the first RAT and the second RAT and the residual frequency error for the communication device;
identify conflicts based on RAT activity periods of both the first RAT and the second RAT; and
implement mitigation for identified conflicts based on the LO spur handling table.

13. The communication device of claim 12, wherein the LO spur handling table correlates spur handling instructions, spur frequency offsets, and spur frequency strengths.

14. The communication device of claim 13, wherein the LO spur handling table correlates spur handling instructions and victim frequencies of the first RAT and the second RAT.

15. The communication device of claim 12, wherein the processor is further configured with processor-executable instructions to identify conflicts based on RAT activity periods, activities, and activity priorities of both the first RAT and the second RAT.

16. The communication device of claim 15, wherein the processor is further configured with processor-executable instructions to:
register the RAT activity periods, activities, and activity priorities of both the first RAT and the second RAT.

17. The communication device of claim 12, wherein the first RAT and the second RAT are operating concurrently.

18. The communication device of claim 12, wherein the processor is further configured with processor-executable instructions to implement mitigation for identified conflicts based on the LO spur handling table by applying a mitigation technique to the first RAT or the second RAT according to the LO spur handling table.

19. The communication device of claim 18, wherein the mitigation technique is notch filtering.

20. The communication device of claim 12, wherein the processor is further configured with processor-executable instructions to implement mitigation for identified conflicts based on the LO spur handling table by turning off an LO of the first RAT or the second RAT based on the LO spur handling table.

21. The communication device of claim 12, wherein turning off an LO of the first RAT or the second RAT based on the LO spur handling table is based at least in part on a relative priority between activities of the first RAT and the second RAT.

22. The communication device of claim 12, wherein the operating frequencies of the first RAT and second RAT are ARFCNs, inter-RAT frequencies, and/or neighbor cell frequencies.

23. A non-transitory processor-readable storage medium having stored thereon processor-executable instructions configured to cause a processor of a communication device to perform operations to mitigate local oscillator (LO) spur interference between radio access technologies (RATs) operating on a communication device, comprising:
registering operating frequencies of a first RAT and a second RAT;
determining LO frequencies for the first RAT and the second RAT based on the registered operating frequencies of the first RAT and the second RAT;
determining a residual frequency error for the communication device;
generating a LO spur handling table based on the LO frequencies for the first RAT and the second RAT and the residual frequency error for the communication device;
identifying conflicts based on RAT activity periods of both the first RAT and the second RAT; and
implementing mitigation for identified conflicts based on the LO spur handling table.

24. The non-transitory processor-readable storage medium of claim 23, wherein the stored processor-executable instructions are configured to cause a processor of a communication device to perform operations such that the LO spur handling table correlates spur handling instructions, spur frequency offsets, and spur frequency strengths and the LO spur handling table correlates spur handling instructions and victim frequencies of the first RAT and the second RAT.

25. The non-transitory processor-readable storage medium of claim 23, wherein the stored processor-executable instructions are configured to cause a processor of a communication device to perform operations such that identifying conflicts based on RAT activity periods of both the first RAT and the second RAT comprises identifying conflicts based on RAT activity periods, activities, and activity priorities of both the first RAT and the second RAT.

26. The non-transitory processor-readable storage medium of claim 23, wherein the stored processor-executable instructions are configured to cause a processor of a communication device to perform operations such that the first RAT and the second RAT are operating concurrently.

27. The non-transitory processor-readable storage medium of claim 23, wherein the stored processor-executable instructions are configured to cause a processor of a communication device to perform operations such that implementing mitigation for identified conflicts based on the LO spur handling table comprises applying a mitigation technique to the first RAT or the second RAT according to the LO spur handling table.

28. The non-transitory processor-readable storage medium of claim 23, wherein the stored processor-executable instructions are configured to cause a processor of a communication device to perform operations such that implementing mitigation for identified conflicts based on the LO spur handling table comprises turning off an LO of the first RAT or the second RAT based on the LO spur handling table.

29. The non-transitory processor-readable storage medium of claim 23, wherein the stored processor-executable instructions are configured to cause a processor of a communication device to perform operations such that the operating frequencies of the first RAT and second RAT are ARFCNs, inter-RAT frequencies, and/or neighbor cell frequencies.

30. A communication device, comprising:
means for registering operating frequencies of a first radio access technology (RAT) and a second RAT;
means for determining local oscillator (LO) frequencies for the first RAT and the second RAT based on registered operating frequencies of the first RAT and the second RAT;
means for determining a residual frequency error for the communication device;
means for generating a LO spur handling table based on the LO frequencies for the first RAT and the second RAT and the residual frequency error for the communication device;
means for identifying conflicts based on RAT activity periods of both the first RAT and the second RAT; and
means for implementing mitigation for identified conflicts based on the LO spur handling table.
